(19) United States
(12) Patent Application Publication
(10) Pub. No.: US 2007/0042088 A1
(43) Pub. Date: Feb. 22, 2007

(54) Individually portioned packaged food product and method for manufacturing the same

(75) Inventors: Susan C. Frinak, Green Bay, WI (US); Stanley S.T. Hong, Green Bay, WI (US); Franco X. Milani, Green Bay, WI (US)

Correspondence Address: BRINKS HOFER GILSON & LIONE, P.O. BOX 10395, CHICAGO, IL, 60610, US

(73) Assignee: Schreiber Foods, Inc.

(21) Appl. No.: 11/205,677

(22) Filed: Aug. 17, 2005

(51) Int. Cl. A23B 7/148

(52) U.S. Cl. 426/106

(57) ABSTRACT

A reformulated food product which may include a food which has been comminuted, and mixed or blended with additional ingredients and filled into a cylindrical web. The web is flattened and all of the openings are hermetically sealed. The transverse hermetic seals divide the product into individual portions, and the individual portions may either be joined to each other to form a group of portions, or separated into individual portions by cutting the web at the transverse seals.

### TECHNICAL FIELD

This application relates, generally, to food products and, more specifically, to food products prepared from reformulated ingredients and a method for packaging the same.

### BACKGROUND

Many untreated food products are subject to contamination and spoilage. To increase the shelf life of the food products, it is often the practice to enclose the food products in a packaging material, either prior to or subsequent to cooking. Providing that the packaging material has suitable characteristics, the shelf life of the food product can be extended for a considerable length of time and, in some cases, the shelf life can be accurately predicted. The packaging may be designed to present the product to the consumer in the form of individualized slices, each of which can be conveniently consumed while unused slices remain protected by the packaging, thus enhancing the shelf life of packages containing multiple individualized slices. Methods of packaging individualized slices are known, and are often applied to such products as cheese. Where meat products are concerned, the handling of the meat products may require elaborate safety measures in order to ensure food safety.

Meat products have also been provided as a cooked-in-package food product. A cooked-in-package hermetically-sealed meat product may primarily consist of raw meat being combined with other ingredients, such as preservatives, emulsifiers, flavorings and the like. The cooked-in-package meat product may also include a small quantity of precooked meat, the meat having been cooked in a manner so as to provide additional flavoring. However, the overall character of the material used to fill the package is that of an uncooked material. The process of cooking the food product inside a sealed package may result in undesirable changes in the consistency of the product, and required both additional ingredients to mitigate this problem and specialized cooking procedures.

### BRIEF SUMMARY

In an embodiment, a packaged food product includes a reformulated food in a hermetically sealed package. The hermetically sealed package is formed as a substantially flat rectangle so as to contain a predetermined quantity of food. The food is packaged and sealed in a continuous manner.

In another embodiment, a method of manufacturing a reformulated food product includes: preparing a reformulated meat by comminuting meat by one or more of chopping, slicing, dicing or shredding, adding other ingredients such as emulsifiers, seasonings, colorants, or preservatives as needed for the product formulation, blending the modified meat and the other ingredients. A tube is formed from a sheet of thermoplastic material, and the reformulated meat is introduced into the tube. Subsequently, the tube is substantially flattened and transverse hermetic seals formed at predetermined periodic intervals along the tube. The transverse hermetic seals are then cut.

In yet another embodiment, a packaged food product has a reformulated meat filling, the meat filling having a consistency such that it can be introduced into a tubular web by extruding or flowing, and the web is substantially flattened and segmented by transverse hermetic seals.

In still another embodiment, a method of packaging a food product, including: providing a reformulated meat; providing a tubular web having a hermetic longitudinal seal; inserting the reformulated meat into the tubular web; and, forming transverse hermetic seals in the flattened tubular web at predetermined intervals to form portions.

### BRIEF DESCRIPTION OF THE DRAWINGS

FIG. 1A illustrates a plan view a web including individual food portions in accordance with an embodiment of the invention, the individual portions being joined into a group of portions;

FIG. 1B is a cross-sectional view of the web of FIG. 1A at a transverse hermetic seal, and taken along line section 1B-1B;

FIG. 1C is a cross-sectional view of the web of FIG. 1A at a mid-point between adjacent transverse hermetic seals and taken along line section 1C-1C;

FIG. 2 is a cross sectional view of the web if FIG. 1A at a mid-point between adjacent transverse hermetic seals and taken along line section 1C-1C, illustrating an alternative configuration of the longitudinal hermetic seal; and

FIG. 3 is a simplified block diagram illustrating a manufacturing process in accordance with an embodiment of the invention.

### DETAILED DESCRIPTION

As used herein, a “food product” means any protein material, or protein material which may be blended with other ingredients. The food product may include any one or more of the flesh of animals such as beef, pig, sheep, poultry, game, fish, shellfish, and other protein materials. The term “meat” is understood to mean at least all of the above protein sources, whether derived from animals or other sources. The food product may be in a cooked or an uncooked state as a component material of a reformulated food, and the food product may comprise the meat with an admixture of other ingredients, the ingredients being added either prior to or subsequent to comminution. In addition to raw meat, the meat may be in the form of an already cooked product where the cooking is performed in bulk, or as in a cooked-in-package product such a sausage.

In one embodiment, the meat, as broadly defined above, is comminuted from the state in which it has originally been prepared (such as a sausage) to reduce the sizes of the pieces thereof. Many of such techniques are known to those skilled in the art, including chopping, slicing, dicing, cubing, shredding and similar processes. The particular processes are selected based on the particular meat and the requirements of the subsequent processing.

The comminuted meat may be reformulated by the addition of various ingredients, each of which is approved for use in the type of food product and process being used. For example, such additives may include, but are not limited to, emulsifiers, seasonings and flavorings, coloring agents, preservatives and viscosity modifiers. Specific examples of additive ingredients include starch or other binders, dextrose/sugar or other non-starch carbohydrates as fillers. Additional additives includes proteins such as those derived from milk and soy, texturizers such as gums and carageenan, gelling agents such as gelatin, preservatives such as hydrocolloids, salt, and acidulators such as scorbic acid. Further additives include flavorings such as spices and small quantities of cooked food products, coloring agents of any type which are approved for the use in meat products, and water. Examples of spices are salt, pepper, herbs and aromatic vegetables. Examples of food colorings are sodium nitrate and sodium nitrite. The additives and the comminuted food may be blended or mixed together to provide a reformulated food.

In one embodiment of the invention, the reformulated food may be cooked or re-cooked, prior to intermediate storage in a hopper or other container in preparation for packaging. Alternatively the reformulated food can be further processed without re-cooking, depending on the formulation. Preferably, the viscosity at a specified temperature is such that it is suitable for further processing by extrusion or flowing so as to be inserted into a package. Subsequent to extruding or flowing the reformulated food into a package and hermetically sealing the package, the packaged reformulated food may be subject to heat treatment to pasteurize or sterilize the packaged product. Further, the viscosity characteristics of the food product are such that, when cooled, the viscosity or other physical properties of the packaged reformulated material are modified. For example, the viscosity increases so that the product may be conveniently handled by a consumer.

Factors which may affect the viscosity of the reformulated food include the relative proportions of muscle and fat, which is typified by distinctions such as between choice and prime grades of beef; the time duration of coarse and fine grinding, and the temperature at which the processing is performed. Further factors may the storage time, and additional ingredients including water and the binding of materials by processes such as hydrogen+ binding, ionic binding and hydrocolloidal binding.

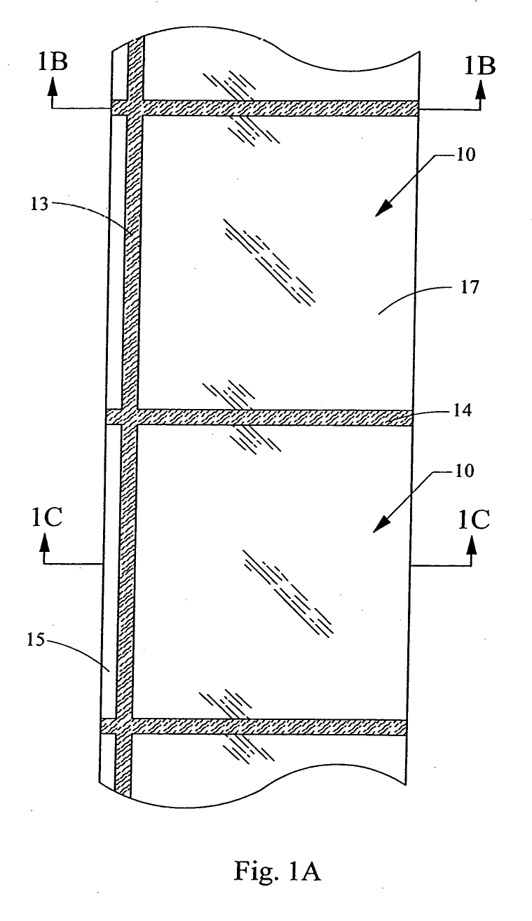

Referring to FIG. 1A-1C, a packaged reformulated food product portion 10 comprises the reformulated food 12, which is enclosed in a hermetically sealed packaging material 17. In one embodiment, the packaged product portion 10 has the properties and appearance of an individualized slice. FIG. 1A shows several individual slice portions of in a state where several of the individual packages are joined together. A web having a longitudinal hermetic seal 13 is formed into a flattened shape, with the reformulated food contained within. At periodic intervals along the web, transverse hermetic seals 14 are formed to segment the reformulated food 12 into individual portions 10. The individual portions are hermetically sealed by the combination of the longitudinal hermetic seal 13 and the transverse hermetic seals 14.

The longitudinal hermetic seal 13 may be formed so that portions 15 of the packaging material 17 extend on the side of the seal opposite to the region containing the precooked reformulated food 12. The extending portions 15 may be folded such that they lay on top of the longitudinal hermetic seal.

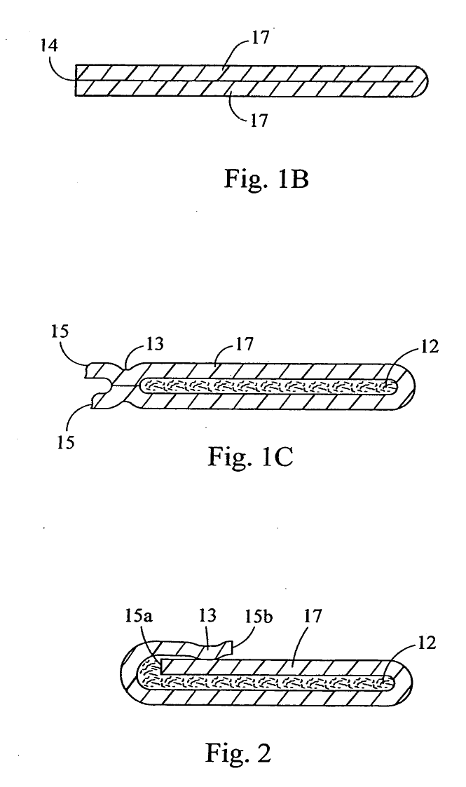

In another alternative, shown in FIG. 2, the hermetic seal 13 may be formed so that the extending portions 15a, b of the packaging material 17 extend in opposing directions from the hermetic seal 13, and that the hermetic seal 13 is not disposed at an edge of the individual portion 10.

The individual slice portions of the product may be manufactured such that they remain connected together at the transverse hermetic seals 14. Alternatively, groups of portions or single portions of the reformulated packaged food product 10 may be formed by cutting the transverse hermetic seals 14 in the direction transverse to the web approximately at a mid-point between each adjacent individual portion 10.

The packaging material is a film which has been formed into a nominally circular web having a longitudinal hermetic seal, the film being one or more of a resin material or other film suitable for food packaging. The choice of film material depends on compatibility with the reformulated food, factors related to shelf life and storage conditions, adhesion between the food and the film, and manufacturing considerations, such as the method used to form the web and the transverse hermetic seals.

A wide variety of food materials may be packaged in this manner, including any food material suitable for processing by comminution, mixing or blending, and extrusion. Also, the food material may be cooked during the preparation steps prior to filling material into the web. Filling the web may be performed at a specified temperature and the packaged material cooled in order to adjust the viscosity or other properties of the packaged material. A condiment such as ketchup or mustard may be blended with, or co-extruded with, the reformulated food prior to or during the filling of the web. As described above, depending on the materials used and the details of the process, the packaged reformulated food product may be pasteurized or sterilized in order to meet product shelf life or regulatory requirements.

An individualized slice of the packaged reformulated food comprises a tubular web, filled by extrusion of the reformulated food. The filled web is substantially flattened such that the flattened web has two substantially parallel faces 17 separated by a predetermined distance. Transverse hermetic seals 14 are formed at predetermined locations along the web, such that the reformulated food is positioned between two successive transverse hermetic seals 14. In this manner, the reformulated food is contained in a hermetically sealed environment. Further processing may be performed as required to enable the product to be stored for a predetermined period under controlled storage conditions.

The tubular web may be formed by folding a continuous web of the packaging material into a V-folded condition, and forming a longitudinal hermetic seal 13 along the open longitudinal edge of the V-folded web. A longitudinal hermetic seal 13 is formed between the inner surfaces of the front and rear faces of the web to define a tubular web member. One method and apparatus suitable for performing this process is disclosed in commonly-owned U.S. Pat. No. 6,058,680 the disclosure of which is incorporated by reference herein. Additionally, other machines and methods may also be used, such as a sausage stuffer, vacuum stuffer or any fill device suitable for use with semi-fluid material. Such machines may be purchased form Reiser Co. (Canton, Mass.; Vemag brand). The web material may be selected from amongst a variety of such materials as suitable for packaging food products as known in the art, such as polypropylene, polyethelene, polyester, nylon, cellophane, polycarbonate and acrylic nitrile. One or more of the materials may be co-extruded or laminated with an oxygen barrier layer such as EVOH, Saran and the like, and with heat activated sealant layers.

Initially, one or more meats or foods is comminuted by one or more of the processes of slicing, dicing, grinding, shredding, or the like, and mixed or blended with additional ingredients. The meat or food may be cooked prior to comminution or during or after blending in order for the packaged food product to meet industry standards and government regulations for human consumption after being stored for a predetermined time under predetermined storage conditions. This state may be described as a reformulated food product.

In a packaging apparatus, such as one as described in U.S. Pat. No. 6,058,680, the packaging material is formed into a tubular web having a longitudinal hermetic seal in a continuous process, and the reformulated food introduced into the tubular web through an orifice. Further steps in the process comprise substantially flattening the web, and segmenting the web into individual portions by forming transverse hermetic seals at periodic intervals are as is known in the art.

The hermetically-sealed portions 10 containing the reformulated food 12 may be treated by cooling in order to modify the viscosity or other mechanical properties of the reformulated food. The portions may be pasteurized or sterilized as necessary. The details of these steps will differ depending on the composition and properties of the reformulated food, and the sterility and shelf-life requirements.

Subsequently, the reformulated food product may be prepared for storage and shipment in several forms. For example, the web may be fan folded such that a stack of individualized portions 10 are formed and remain connected together. The number of connected individualized portions 10 will depend on the next level of packaging, or the processing characteristics of a dispenser. When the required quantity of individualized portions has been accumulated, the web may be severed by cutting a transverse hermetic seal 14. The cut is sufficiently distant from the adjacent reformulated food so that the hermeticity of the transverse seal 14 is maintained. Whenever a cut in the transverse direction is required, the location of the cut is presumed to meet this requirement.

In another aspect, each of the transverse hermetic seals 14 may be cut in the direction transverse to the web, such that the cut extends the full distance between the two opposite edges of each transverse hermetic seal 14. This creates separate individualized portions, which may be packed and used one at a time.

In yet another aspect, the reformulated food may be produced from raw or precooked food materials which may be comminuted without intermediate packaging. The reformulated food is then mixed or blended with any of the additive ingredients as previously described, and stored in a hopper for insertion in the web. A cooking process may be performed during or after the mixing or blending operations, if required. The reformulated food is packaged as previously described.

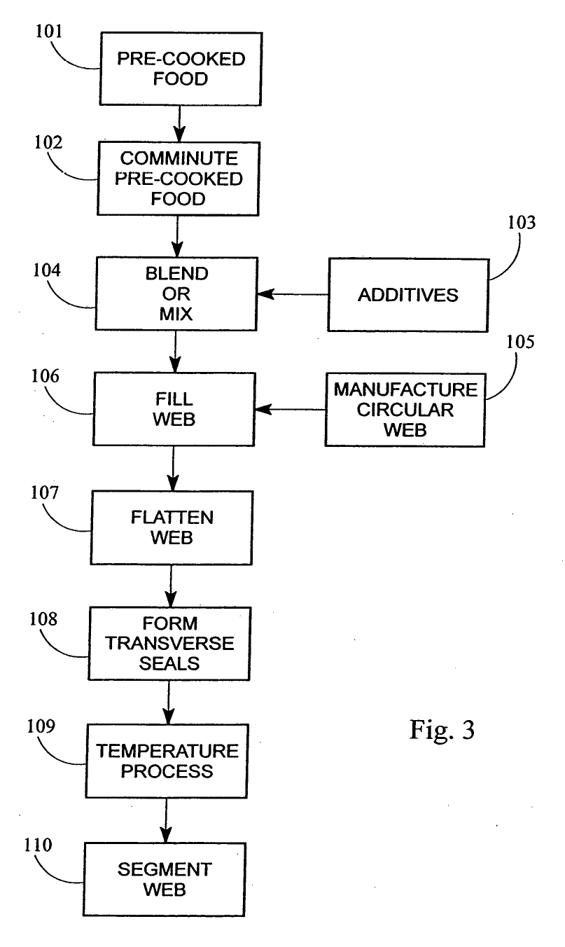

The method of packaging is described in FIG. 3. Step 101 is the beginning of the process, where a selected food product is provided. In step 102, the food is comminuted. Additive ingredients in accordance with the product formulation are provided in step 103, and blended or mixed with the comminuted food in step 104 to form the reformulated food. It should be noted that steps 103 and 104 may be repeated as necessary to take account of the various ingredients, which may each require separate handling in order to be properly combined. The comminuted food or food mixture may be cooked prior to, during, or subsequent to the blending or mixing process. A circular web is formed in step 105, such that it is positioned so as to be filled with the reformulated food in step 106 by flowing or extrusion. Having been filled with the reformulated food, the web is flattened in step 107 to the thickness required for the product. This thickness is determined by the planar size of the individual portion to be formed and the desired packaged product weight. Transverse hermetic seals are formed at periodic intervals in the longitudinal direction of the web in step 108 and, if required, cooling performed to modify the mechanical properties. In step 109, the food product is heated to achieve pasteurization or sterilization. The continuous web is fan-folded, or individualized as necessary for further packaging and dispensing in step 110.

By way of example and not by way of limitation, the following examples are provided to give a further appreciation of aspects of the inventive food product and method.

Turkey Ham Meat Singles

This individualized product comprises a precooked meat product, and is again cooked after comminution and blending with other ingredients. The precooked meat product is a commercially available turkey ham sausage, such as sold in a supermarket. The ingredients for this product are given in Table 1, showing the range of proportions and the commercial sources employed including two specific formulations which have been experimentally produced. Generally, the common name of the ingredient is sufficient to identify the ingredient for purposes of producing the packaged reformulated food products described herein, however the specific names of the ingredients used in the examples, and their commercial sources, are provided.

The precooked food product used in the examples is a turkey-ham sausage that is commercially available, and may be obtained from manufacturers such as Armour (a brand of The Dial Corporation, Scottsdale, Ariz.) and Oscar-Meyer (a brand of Kraft Foods, Inc., Northfield, Ill.). Preferably the reformulated food product includes about 22% to about 55% meat by weight and more preferably about 36% to about 39% meat by weight. Unless otherwise stated, all percentages are weight percentages with respect to the overall batch weight, the weight of each ingredient being measured in the state in which it is introduced into the batch.

In the present example, starch is used as a gelling agent and to give the individualized portion physical properties such that it may be handled without easily tearing or crumbling. In the present example, TB-65 starch obtained from National Starch and Chemical Co., Bridgewater, N.J. The food product preferably includes about 3% to about 15% starch, and more preferably about 8% starch. The food product includes about 25% to about 55.5% water, and more preferably about 38% and 39% water. The water content is adjusted such that the weight percentages of the ingredients of the batch are equal to 100%. In the present example, Dextrose #333 obtained from National Starch and Chemical Co., Bridgewater, N.J. is used as a non-starch carbohydrate. The food product preferably includes about 0.5% to about 10% non-starch carbohydrate primarily as filler, and more preferably about 2% non-starch carbohydrate. Whey protein concentrate, sodium hexameta-phosphate and trisodiumpyrophosphate (TSPP) are used as emulsifiers. In this example, the food product includes about 2% to about 10% Whey Protein Concentrate 80 available from Davisco Foods international, Inc. Eden Prairie, Minn., and more preferably about 6%; about 0% to about 2% sodium hexameta-phosphate obtained from Univar, Milwaukee, Wis. and more preferably about 0.2% to about 0.5%; and about 0% to about 2% trisodiumpyrophosphate (TSPP), obtained from Mitsui and Company Ltd., Purchase, N.Y., and more preferably about 0% to about 0.9% are used as emulsifiers.

Further ingredients in this example include about 1% to about 10% Gelatin 250 bloom, obtained from Danisco, New Century, Kans., as a binder, and more preferably about 3% binder. About 0% to about 2% scorbic acid, obtained from APAC Chemical, Santa Fe Springs, Calif. is used to adjust the pH of the mixture; more preferably about 0.2% to about 0.5% is used. About 0% to about 1% GENU Texturizer MB-80F, obtained from GP Kelco, Chicago, Ill., is used a hydrocolloid thickener and stabilizer and more preferably a percentage of about 0.8% is used.

TABLE 1
Ingredients for Turkey Ham Meat Singles

| | | Example 1, | Example 2, |
|---|---|---|---|
| Ingredient | % Range | % | % |
| Turkey Ham Sausage | 25-55 | 39.6 | 38.5 |
| TB-65 Starch | 3-15 | 8.0 | 8.0 |
| Dextrose #333 | 0.5-10 | 2.0 | 2.0 |
| Whey Protein Concentrate 80 | 2-10 | 6.0 | 6.0 |
| Salt | 0.5-3.5 | 1.3 | 1.4 |
| Sodium Hexameta-phosphate | 0-2 | 0.2 | 0.5 |
| Gelatin 250 Bloom | 1-10 | 3.0 | 3.0 |
| Scorbic Acid | 0-2 | 0.2 | 0.2 |
| Trisodiumpyrophosphate | 0-2 | 0 | 0.9 |
| (TSPP) | | | |
| Water | 25-55.5 | 39.7 | 39.5 |
| Genu Texturizer MB-80F | 0-1 | 0.8 | 0.8 |

The proportions listed in Table 1 as Examples 1 and 2 were utilized to manufacture test samples of the product. The following manufacturing procedure was used in each example, the difference in the examples being the proportions of the ingredients.

The Turkey Ham Sausage was comminuted by chopping for 5 minutes by a Hobart “Sidleman” Cutter, model 84186 (Hobart, Troy, Ohio), to a fine grind state. Water was added to a twin-screw Rietz Cooker, and the combination of the water and the comminuted food product was blended for about 5 to 10 minutes. The remainder of the ingredients are added and the resultant combination blended for about 5 minutes to form a reformulated food. The reformulated food is then cooked using a steam injection process wherein the temperature of the reformulated food, was raised to between approximately 150° F. and approximately 200° F., and the temperature is maintained for between about 30 seconds and about 10 minutes. At the conclusion of the cooking process the reformulated food is transferred to a hopper in preparation for packaging. When in a state immediately prior to packaging, a viscosity of between approximately 200 and approximately 500 cps at a temperature of approximately 160° F. to approximately 190° F. has been found acceptable.

The reformulated food in the hopper was extruded into a continuously formed tube of packaging material using the apparatus and process described in U.S. Pat. No. 6,058,680. During the packaging process, the hermetically sealed food material was cooled and transverse hermetic seals formed to provide individual portions of slice-like product.

The composition and pH of the reformulated food are given in Table 2, where the value range corresponds to the value range in Table 1, and is an estimate, and the specific values are based on an analysis of the test products manufactured in Examples 1 and 2 as described, with the corresponding values of the input ingredients.

TABLE 2
Composition and Attributes of Turkey Ham Meat Singles

| Composition and pH | Value Range | Example 1 | Example 2 |
|---|---|---|---|
| Moisture | 50-75% | 73.0% | 70.0% |
| Salt | 1-3% | 1.5% | 2.0% |
| Fat | 0.5-5% | 3.12% | 1.26% |
| Protein | 10-35% | 15.36% | 13.54% |
| Carbohydrates | 4-20% | 9.52% | 9.70% |
| Other | 0.1-1.0% | 0.5% | 0.5% |
| pH | 5.3-6.3 | 6.75 | 6.0 |

The resultant portions have a physical appearance similar to that of a cheese slice, but have a meat texture and color, and a mild turkey-ham-like flavor.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

It is therefore intended that the foregoing detailed description be regarded as illustrative rather than limiting, and that it be understood that it is the following claims, including all equivalents, that are intended to define the spirit and scope of this invention.

What is claimed is:

1. A packaged food product comprising:
a reformulated food packaged in a hermetically sealed material,
wherein the hermetically sealed material comprises a substantially flat rectangle and contains a predefined quantity of the reformulated food, and wherein the reformulated food is configured such that it can be packaged and sealed in a continuous process.

2. The product according to claim 1, wherein at least a surface of the
hermetically sealed material has heat sealable characteristics.

3. The product according to claim 2, wherein the surface comprises a thermoplastic material.

4. The product according to claim 2, wherein the surface comprises a thermosetting adhesive.

5. The product according to claim 1, wherein the material comprises a composite material, at least one layer of which is oxygen impervious.

6. The product according to claim 1, wherein the hermetically sealed material is configured so as to have a hermetically-sealed longitudinal seam.

7. The product according to claim 6, wherein the reformulated food has a consistency such that the reformulated food can flow or be extruded.

8. The product according to claim 7, wherein a portion of the product is bounded by successive transverse hermetic seals.

9. The product according to claim 8, wherein the portions are configured to be separated by cutting the transverse hermetic seal.

10. The product according to claim 7, wherein the reformulated food is at a temperature of between approximately 150° F. and approximately 190° F.

11. The product according to claim 10, wherein the reformulated food is configured so as to have a viscosity of between approximately 200 cps and approximately 5000 cps.

12. The product according to claim 1, wherein the reformulated food is cooked.

13. The product according to claim 1, wherein the reformulated food comprises meat comminuted by at least one of grinding, chopping, slicing or shredding, and wherein the comminuted meat is blended with ingredients comprising at least one of emulsifiers, seasonings, colorants or preservatives.

14. The product according to claim 13, wherein the reformulated food is cooked.

15. The product according to claim 13, wherein the reformulated food further comprises comminuted meat and a condiment.

16. A method of manufacturing reformulated food products, the method comprising:
(a) preparing a modified meat, comprising comminuting a meat by at least one of chopping, slicing, dicing or shredding;
(b) adding ingredients, comprising at least one of emulsifiers, seasonings, colorants, or preservatives;
(c) forming a blended material comprising the ingredients and the modified meat by a method comprising at least one of blending or mixing;
(d) forming a tube from a sheet of thermoplastic material, the tube being hermetically sealed in a longitudinal direction;
(e) introducing the blended material into the tube;
(f) forming a substantially flattened tube;
(g) forming transverse hermetic seals at periodic intervals in the substantially flattened tube; and
(h) cutting the transverse hermetic seals.

17. The method of claim 16, wherein the method further comprises cooking the meat prior to preparing the modified meat.

18. The method of claim 17, wherein the method further comprises cooking the blended material prior to introducing the blended material into the tube.

19. The method of claim 16, wherein the method further comprises pasteurizing the blended material after forming the substantially flattened tube.

20. The method of claim 16, wherein the blended material has a viscosity between about 200 cps and about 5000 cps at a temperature of between about 160° F. and about 190° F.

21. The method of claim 16, wherein preparing the meat and adding the ingredients further comprises providing commercially sterile food substances prior to preparing and adding.

22. The method of claim 16, wherein introducing the blended material into the tube comprises introducing a commercially sterile blended material into the tube.

23. The method of claim 16, wherein introducing the blended material into the tube comprises co-extruding the blended material with a condiment.

24. A packaged food product comprising:
a reformulated meat filling; and
a tubular web having a hermetically sealed longitudinal member, the reformulated meat filling having a consistency such that it can be introduced into the tubular web by a method comprising one of extruding or flowing,
wherein the web is substantially flattened and the web segmented by transverse hermetic seals.

25. The product of claim 24, wherein the transverse hermetic seals are configured such that they can be separated by cutting the transverse hermetic seal in a direction transverse to a web axis.

26. A method of packaging a food product, the method comprising:
(a) providing a reformulated meat;
(b) providing a tubular web having a hermetic longitudinal seal;
(c) inserting the reformulated meat into the tubular web;
(d) flattening the tubular web; and
(e) forming transverse hermetic seals in the flattened tubular web at predetermined intervals to form portions.

27. The method of claim 26, further comprising cutting the web transversely at a mid-point of the transverse hermetic seal.

28. The method of claim 27, further comprising heat treating.

29. The method of claim 28, wherein the heat treating comprises pasteurization.

30. The method of claim 26, further comprising treating the portions to meet commercial sterility requirements.

31. The method of claim 26, wherein providing a tubular web further comprises providing an oxygen impervious plastic.

32. The method of claim 26, wherein providing a reformulated meat comprises providing a reformulated meat having a viscosity of between about 200 cps and about 5000 cps at a temperature of between about 160° F. and about 190° F.
